(19) United States
(12) Patent Application Publication
(10) Pub. No.: US 2010/0144322 A1
(43) Pub. Date: Jun. 10, 2010

(54) Invoking A Service In An Intelligent Network

(76) Inventor: Rogier August Caspar Joseph Noldus, Goirle (NL)

Correspondence Address: ERICSSON INC., 6300 LEGACY DRIVE, M/S EVR 1-C-11, PLANO, TX, 75024, US

(21) Appl. No.: 12/522,454

(22) PCT Filed: Jan. 8, 2007
(86) PCT No.: PCT/NL2007/050004

§ 371 Date: Feb. 25, 2010

(51) Int. Cl. H04M 3/42

(52) U.S. Cl. 455/414.1

(57) ABSTRACT

Method and devices for invoking a service in a telecommunications network with a switching node (18) and an intelligent network. The intelligent network has a service 5 control entity (16) and a service switching entity (17). The switching node (18) receives a request to set up a call, determines if the call requires invocation of a service in the intelligent network, and if so, instructs the service switching entity (17) and proceeds set up of the call. Proceeding set up of the call is executed before an instruction from the service switching entity (17) is received, allowing continuation of the call set up 10 without introducing any delays. The service control entity (16) and service switching entity (17) perform further functions to support the switching node.

### TECHNICAL FIELD

The present invention relates to a method for invoking a service in a telecommunications network comprising a switching node and an intelligent network, the intelligent network comprising a service control entity and a service switching entity, wherein the switching node receives a request to set up a call, determines if the call requires invocation of a service in the intelligent network, and if so, instructs the service switching entity, and proceeds set up of the call. The switching node is e.g. a mobile switching center (MSC) in a mobile telecommunications network, and the service switching entity is e.g. a service switch function (SSF). The service control entity may be a service control point (SCP), known as such in mobile telecommunications networks. Furthermore, the present invention relates to methods for invoking a service in a telecommunications network relating to specific functionalities of the service switching entity, the service control entity, or a combination of the switching node, service switching entity, and the service control entity.

In a further aspect, the present invention relates to a switching node in a telecommunication, a service switching entity in an intelligent network or a service control entity in an intelligent network.

### BACKGROUND

This method may be applied in mobile communication networks, in which case the exchange or switching node, which is a basic entity in a network for establishing connections between network terminals, is a mobile switching center (MSC). Determining whether the call to be initiated further requires initiation of a service (e.g. an Intelligent Network (IN) service), is e.g. implemented by analyzing various call related parameters.

Normally, the initiation of a service entails that call set up by the exchange is suspended, until the initiation of the service is reported back to the exchange and the service has given further instruction. This is e.g. described in GSM specifications TS03.78 and TS09.78 for a GSM communication network as is known to the person skilled in the art. In various applications, e.g. when call establishment is critical, such a suspension or waiting period in the call set up is not desired.

### SUMMARY

The present invention seeks to provide a solution wherein disadvantageous effects of such a suspension or waiting period are minimized.

According to the present invention, a method according to the preamble defined above is provided, in which proceeding set up of the call is executed before an instruction from the service switching entity is received. This allows to minimize the waiting period and directly proceed with the call set up (independent from the service invocation).

In a further embodiment, determining if the call requires invocation of a service in the intelligent network comprises checking whether there is a trigger detection point in notify mode (TDP-N) applicable for the call. Using a TDP in notify mode allows to continue call set up immediately without delay, as in conventional methods where in such a case a trigger detection point in report mode (TDP-R) is used.

Instructing the service switching entity comprises in a further embodiment sending an indication that the set up of the call is not suspended. This allows to maintain the relation between the switching node and the service switching entity.

A further embodiment relates to the situation where a service needs to be invoked during an existing call. In this embodiment, the method further comprises receiving a notification that a first state model in the switching node having a plurality of detection points associated with the call has made a transition to a detection point, determining if the transition is to be reported to the service switching entity and if so, reporting the transition and continuing the call before an instruction from the service switching entity is received. With this embodiment, it is also possible to invoke a service in a more efficient manner during an existing call.

Furthermore, the present invention relates to specific functionality of the service switching entity, i.e. a method for invoking a service in a telecommunications network comprising a switching node and an intelligent network, the intelligent network comprising a service control entity and a service switching entity, wherein the service switching entity receives an instruction from the switching node, selects a predefined set of detection points in accordance with the received instruction, sends a message to the service control entity, receives a response from the service control entity, and arms the detection points from the selected predefined set. The instruction comprises an indication that the call set up is not suspended in a further embodiment. The message is e.g. an Initial Detection Point (IDP) message comprising an information element indicating the predefined set of detection points and comprising an indication that the call set up is not suspended.

In a further embodiment, the method further comprises receiving a report that a first state model in the switching node having a plurality of detection points associated with the call has made a transition to a detection point, selecting a predefined set of detection points in accordance with the received notification, determining if the transition is to be reported to the service control entity, and if so, sending a message comprising an indication of the transition and comprising an information element indicating the predefined set of detection points to the service control entity, and arming the detection points from the selected predefined set.

Also, the present invention relates to specific functionality of the service control entity, i.e. a method for invoking a service in a telecommunications network comprising a switching node and an intelligent network, the intelligent network comprising a service control entity and a service switching entity, wherein the service control entity receives a message from the service switching entity comprising an information element indicating a predefined set of detection points to be armed by the service switching entity, invokes the service, aligns a second state model in the invoked service in accordance with the predefined set of detection points, and sends a response to the service switching entity (acknowledging the IDP).

According to an embodiment, the message from the service switching entity is an Initial Detection Point message. The message, in a further embodiment comprises an indication that the call set up is not suspended.

Furthermore, an embodiment of the present method further comprises receiving a message comprising a notification that a first state model in the switching node having a plurality of detection points associated with the call has made a transition to a detection point, and comprising an information element indicating a predefined set of detection points to be armed by the service switching entity, and aligning the second state model in the invoked service in accordance with the transition and with the predefined set of detection points.

The present invention is also embodied as the functionality of an ensemble of network nodes in a telecommunications network, i.e. a method for invoking a service in a telecommunications network comprising a switching node and an intelligent network, the intelligent network comprising a service control entity and a service switching entity, wherein the switching node receives a request to set up a call, determines if the call requires invocation of a service in the intelligent network, and if so, instructs the service switching entity and proceeds set up of the call before an instruction from the service switching entity is received, wherein the service switching entity further selects a predefined set of detection points in accordance with the received instruction, sends a message to the service control entity, receives a response from the service control entity, and arms the detection points from the selected predefined set, and wherein the service control entity further invokes the service, aligns a second state model in the invoked service in accordance with the predefined set of detection points and sends a response to the service switching entity. The method in a further embodiment comprises the combination of functionalities of the switching node, service switching entity and service control entity for the case when a service needs to be invoked during an existing call, as described in claim 14.

In a further aspect, the present invention relates to a switching node in a telecommunication network, a service switching entity, or a service control entity, which interact and are arranged to execute the method embodiments of the present invention.

In an even further aspect, the present invention relates to a computer program product comprising computer executable code, which when loaded on a computer system, allows the computer system to execute the method according to any one of the embodiments above.

### BRIEF DESCRIPTION OF THE DRAWINGS

The present invention will be discussed in more detail below, using a number of exemplary embodiments, with reference to the attached drawings, in which

FIG. 1 shows a simplified schematic diagram of a communication network in which embodiments of the present invention may be implemented;

FIG. 2 shows a Basic Call State Model which is utilized in embodiments of the present invention;

FIG. 3 shows a timing sequence of messages exchanged between a Service Switching Function and a Service Control Function in an exemplary embodiment;

FIG. 4 shows a timing sequence of messages exchanged between a Service Switching Function and a Service Control Function in a further exemplary embodiment;

FIG. 5 shows a timing sequence of messages exchanged between a Service Switching Function and a Service Control Function in an even further exemplary embodiment;

FIG. 6 shows a flow diagram of steps executed by a mobile switching center (MSC) at call set up in an embodiment;

FIG. 7 shows a flow diagram of steps executed by a MSC when a service is requested during a call in a further embodiment;

FIG. 8 shows a flow diagram of steps executed by a service switching function (SSF) at call set up in an embodiment;

FIG. 9 shows a flow diagram of steps executed by a SSF when a service is requested during a call in a further embodiment;

FIG. 10 shows a flow diagram of steps executed by a service control point (SCP) at call set up in an embodiment;

FIG. 11 shows a flow diagram of steps executed by a SCP when a service is requested during a call in a further embodiment;

FIG. 12 shows a timing sequence of exchange of messages exchanged in a telecommunication network in an exemplary embodiment;

FIG. 13 shows a timing sequence of exchange of messages exchanged in a telecommunication network in a further exemplary embodiment; and

FIG. 14 shows a block diagram of an embodiment of a device performing one or more of the MSC/SSF/SCP functions of the present invention.

### DETAILED DESCRIPTION

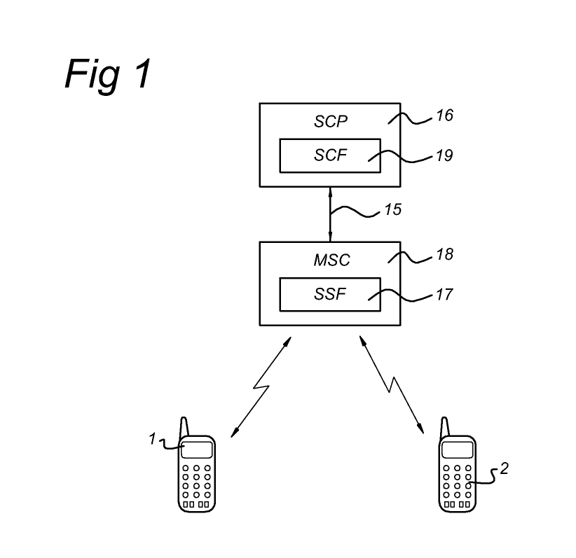

The present invention may be applied in communication networks, e.g. a mobile telecommunication network. The relevant parts of such a telecommunication network are shown schematically in FIG. 1. The telecommunication network provides for communication between two or more terminals 1, 2, of which one is designated originating terminal 1, and another one destination terminal 2. The terminals 1, 2 (or mobile stations) are arranged to communicate wirelessly with an exchange, in this case the Mobile Switching Center (MSC) 18. The exchange 18 is arranged to establish a call between an originating terminal 1 and a destination terminal 2. In modern mobile telecommunication networks, the MSC 18 also hosts a (software) module for interfacing with other network units in the telecommunication network, indicated by the block Service Switching Function (SSF) 17. The SSF 17 may also be implemented as a separate node, called a Service Switching Point (SSP). Present day telecommunication networks offer intelligent network (IN) services, which are executed by a Service Control Point (SCP) 16. The SCP 16 hosts functional modules, such as the Service Control Function (SCF) 19, and is able to communicate with the SSF 17, e.g. using a messaging protocol such as CAMEL (Customized Applications for Mobile Enhanced Logic) or INAP (Intelligent Networks Application Part).

The MSC 18, SSF 17 and the SCP 16 may be implemented as network units 1401, the structure of which is shown in simplified form in FIG. 14. The network unit 1401 comprises a processing unit 1403 connected to an input unit 1402. Furthermore, the processing unit 1403 is connected to an output unit 1404. These allow the processing unit 1403 to communicate with other network units 1403 or other elements in the communication network. The processing unit 1403 may comprise a general purpose central processing unit (CPU) or a group of interconnected CPU's, or alternatively a dedicated processing unit, e.g. a signal processing unit. A memory module 1405 may also be provided and may be used to store data, but also to store a software program comprising instructions, which allows to use the processing unit 1403 for various processing functions. E.g. it is possible that one network unit 1401 under the control of a software program fulfils the function of the MSC 18 and at the same time the function of the SSF 17.

In known methods of invoking or initiating an IN service, the MSC 18 (or SSF 17) notifies the SCP 16 (or SCF 19). However, when the SSF 17 has triggered the respective IN service, the SSF 17 will wait for further instructions from the IN service. The SSF 17 Finite State Machine (FSM) has made a transition to the state ‘Waiting for Instructions (WfI)’, and the call establishment process is now suspended. Call establishment continues only when the SSF 17 has received a ‘Continue’ (CUE) operation from the SCP 16 or SCF 19.

For cases where call establishment is critical, it may not be desirable to suspend the call establishment process. One example is the invocation of an IN service for emergency calls. Embodiments of the present invention are arranged to provide a method in which an IN service is invoked without suspending the call establishment process, in which the relationship between the IN service and the MSC 18 (or SSF 17) may be retained after service invocation, without explicit request from the IN service, and in which the IN service receives call establishment process notifications in accordance with existing IN mechanisms.

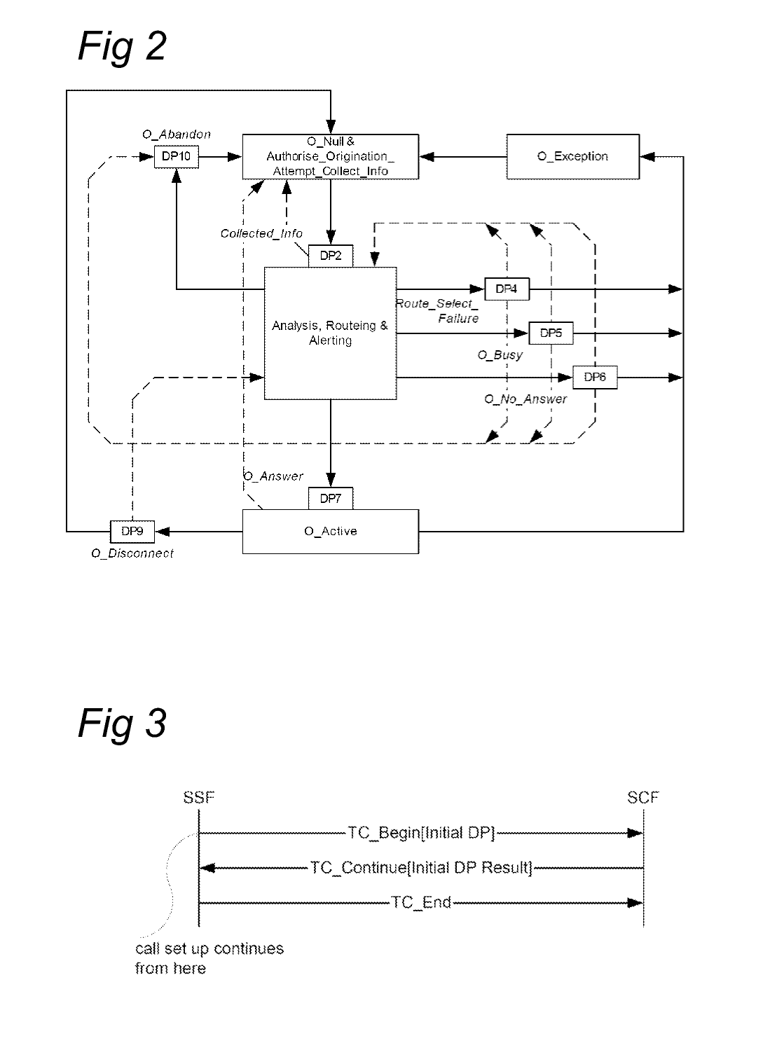

The method described below in accordance with a number of embodiments of the present invention entails that an SSF 17 can apply implicit arming of Detection Points (DP). Detection Points are a method used in the description of state models of present day telecommunication networks (called Basic Call State Model, BCSM). Detection Points represent predefined events in e.g. the establishment of a call in the telecommunication network. In accordance with existing IN methodology, an instance of a BCSM is invoked when the MSC 18 has deduced that a call shall be subject to IN control. The type of BCSM that is instantiated depends on the call case. For a Mobile Originating (MO) call for which a CAMEL Phase 2 service shall be invoked, an O-BCSM (Originating BCSM) is instantiated, as shown schematically in FIG. 2.

The O-BCSM consists of various Detection Points (DP) and Points in Call (PiC), such as the indicated O_Active PiC. The basic call transitions are indicated by solid lines, and transitions beyond basic call are indicated by broken lines. Basic state model transitions are those transitions that follow from the structure of the BCSM. State model transitions beyond basic call are those transitions that are enforced by a service control entity.

In the normal situation, a CAMEL service is started as a result of the static arming of a DP as Trigger Detection Point (TDP) in “Request Mode” (TDP-R). For a CAMEL Phase 2 service for a mobile originated or mobile forwarded call, the DP that may be statically armed as TDP-R is DP Collected_Info (DP2).

The CAMEL service that is now started by the SCF 19, residing in the SCP 16, may arm additional DPs in the BCSM instance in the SSF 17. These DPs are in that case dynamically armed. A DP that is dynamically armed within a service instance is referred to as an EDP (Event Detection Point).

This leads to the following distinction:

TDP: A TDP is a DP that is statically armed in the MSC 18; the CAMEL service is triggered when the conditions that are associated to this TDP are fulfilled. According to CAMEL and Capability Set 1 (CS1) standards, a TDP is always “TDP-R”; that means that when the SSF 17 has initiated the service processing, the call processing in the MSC 18 is suspended and the SSF 17 waits for further instructions from the service (in the SCF 19).

EDP: An EDP is a DP that is dynamically armed by a service instance. The conditions for arming a DP are determined by the service (in the SCF 19), not by the SSF 17. A DP may be armed as EDP-N (Notify mode) or as EDP-R (Request mode). In the former case (EDP-N), the occurrence of the event is reported to the service and call handling in the MSC 18 continues. In the latter case (EDP-R), the occurrence of the event is reported to the service and call handling in the MSC 18 is suspended.

When an IN service requires further call process notifications, that service needs to be triggered by means of a TDP-R, enabling the service to arm subsequent service events. The effect of the service triggering by means of a TDP-R is that the call establishment process is suspended. As discussed earlier, suspending the call establishment process may not always be desirable.

The present invention presents two elements that offer a solution to the above-described dilemma (and which may be used as such or in combination):

Use of a TDP-N (Trigger Detection Point—Notify mode):

A TDP-N is a DP that is statically armed in the MSC 18. A distinctive aspect of a TDP-N, compared to TDP-R, is that the call establishment process is not suspended when the service is started.

Implicit arming of Detection Points:

Implicit arming of Detection Points entails that when the SSF 17 has invoked an IN service, it automatically arms designated DPs in the BCSM instance.

In the following, an exemplary embodiment will be described in more detail. When a call is established between an originating terminal 1 and a destination terminal 2, the MSC 18 may deduce from designated call related parameters that an IN service shall be invoked for this call. This deduction triggers the MSC 18 to hand over control of the call to the SSF 17. The SSF 17 determines which IN trigger data apply for this call. The IN trigger for this call contains a TDP-N definition. The SSF 17 prepares an Initial Detection Point (IDP) operation in accordance with existing IN specifications. The SSF 17 then sends the IDP to the SCP 16. The IDP is sent in a TCAP (Transaction Capabilities Application Part) TC_Begin message.

The SSF 17 applies the following two steps:

Implicit TDP disarming: Regular IN service triggering entails that when the IN service is triggered, the TDP-R that led to the service triggering remains armed until the service sends a call continuation operation, such as ‘Continue’ (CUE). When, however, an IN service is triggered with a TDP-N, as proposed by the present invention, then this TDP-N is implicitly disarmed upon its occurrence and reporting (see e.g. the TC_Begin[Initial DP] message in FIG. 3 which is sent from the SSF 17 to the SCF 19). Consequently, the MSC 18 may continue its call processing immediately after the service invocation has taken place, i.e. immediately after the IDP operation is sent.

Implicit EDP arming: In order to be able to report subsequent call events to the service, the SSF 17 applies implicit arming of DPs. That means that the service need not explicitly instruct the arming of these events (which is normally done by a Request Report BCSM operation), it is done implicitly by the SSF 17. Designated DPs in the O-BCSM instance are armed as EDP-N.

In one particular embodiment, the SSF 17 may apply the following implicit arming of DPs, as indicated in the following Table.

| Detection Point | Arming mode |
|---|---|
| O_Busy | EDP-R |
| O_No Answer | EDP-R |
| Route_Select_Failure | EDP-R |
| O_Abandon | EDP-R |
| O_Answer | EDP-N |
| O_Disconnect | EDP-R |

Some of the DPs may be armed as an EDP-R, and other as an EDP-N. The rationale why in this exemplary embodiment it is indicated that O_Answer be implicitly armed as EDP-N is that the reporting of the Answer event should not lead to suspension of the call process. If the BCSM instance in the SSF 17 would be suspended as a result of reporting the Answer event, then the speech connection between the calling party and the MSC 18 is not established. As a result, there could be (minimal) additional delay in full speech path establishment. The other events indicated relate to call establishment failure or call clearing. For those events, (minimal) additional delay in call processing is not harmful. A further rationale for arming e.g. the O_Disconnect DP as EDP-R is that, according to existing IN rules, at least one DP shall be armed as EDP-R in order for the IN service to be able to release the call.

The implicit arming rules that need to be applied depends on the IN service that is invoked. An SSF 17 may have different sets of internally defined IN service trigger data for different IN services. One such set of IN service trigger data may contain a TDP-N as the detection point and (optionally) a set of implicit arming rules.

After the SSF 17 has implicitly armed the DPs, the SSF 17 applies pre-arranged end rules, as per regular IN methodology. Applying pre-arranged end rules entails the following check:

IF any detection points are armed OR any reports are pending

THEN maintain IN relationship;

ELSE terminate IN relationship.

Implicit arming of DPs, as described relating to embodiments of the present invention, has the effect that the condition as defined after the IF statement is fulfilled; the IN relationship is therefore maintained.

From the moment that the call establishment continues, the IN service simultaneously continues in accordance with existing IN methodology. That means that when a call event occurs, such as Answer, then this event will be reported to the SCP 16, depending on the arming state of the corresponding DP at that moment.

Exemplary embodiments are illustrated in the message sequences as shown in the FIGS. 3-5. The IN service terminates in accordance with existing pre-arranged end rules.

In the example shown in FIG. 3, no implicit arming of DPs has taken place. After the TC_Begin[Initial DP] message is sent from the SSF 17 to the SCF 19, the SCF 17 acknowledges the message to the SSF 17 using a TC_Continue[Initial DP Result] message. Upon reception of this message, the SSF 17 terminates the IN service by sending a TC_End message to the SCF 19. Note that the call setup by the MSC 18 already progresses from the point where the TC_Begin[Initial DP] message is sent.

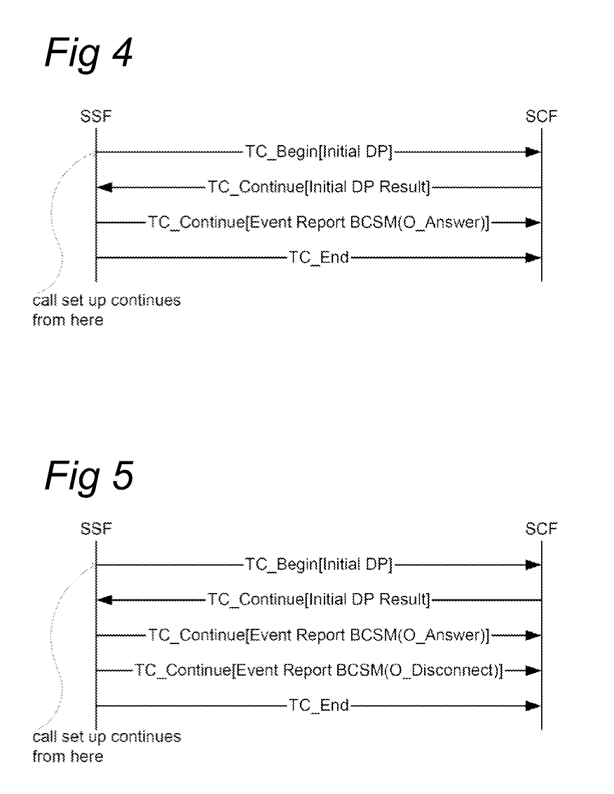

In the example shown in FIG. 4, the call answer DP and the call establishment failure DPs are armed, but not the Disconnect DPs. Once the SSF 17 has reported an event associated with the armed DP (in this case using a message TC_Continue[Event Report BCSM(O_Answer)]) it progresses by sending the TC_End message to the SCF 19 to terminate the IN service.

In the example shown in FIG. 5, all DPs as listed in the table above are implicitly armed, except for DP O_Disconnect, which is armed as EDP-N as opposed to EDP-R. In this case, the IN service is only terminated by the SSF 17 sending a TC_End message when the call is terminated (as reported to the IN service using a TC_Continue[Event Report BCSM(O_Disconnect)] message).

Service termination requires no additional mechanism; the SSF 17 resources will be released when the call terminates and the service is terminated as described above.

The Initial DP Result (message TC_Continue[Initial DP Result] as shown in the FIGS. 3-5) is waited for by the SSF 17 before being able to send any subsequent TCAP message(s). The Initial DP Result contains a TCAP dialogue identifier that the SSF uses when sending subsequent TCAP message(s).

Implicit disarming rules are defined for a specific IN protocol, such as CS1 or Camel Application Part v2 (CAP v2). If a different set of implicit disarming rules are applied or when implicit arming rules are applied, then the following options exist:

A different protocol (dedicated Application Context) is used. The serving SCP 16 uses the appropriate protocol stack for this service, including the implicit arming and implicit disarming rules that are defined for this protocol.

The implicit arming and implicit disarming rules are conveyed to the service logic, e.g. by means of an Extension container in the IDP operation. This method would be suitable if the implicit (dis)arming rules and pre-arranged end rules are handled by the service logic, rather than by the SCP 16.

The implicit arming and implicit disarming rules are conveyed to the SCP, e.g. by means of an information element in the TCAP dialogue portion.

In the embodiments described above, implicit arming is applied at service invocation. In a further embodiment, implicit arming is also applied at designated DPs, such as the DP O_Answer (DP7 in FIG. 2). As an example, the DPs O_Busy (DP5), O_No_Answer (DP6), Route_Select_Failure (DP4), O_Abandon (DP10) and O_Answer (DP7) are implicitly armed at TDP-N (DP Collected_Info (DP2)), i.e. when the service is initiated. DP O_Disconnect (DP9) is implicitly armed when DP O_Answer (DP7) occurs. The rationale of this approach is that DP O_Disconnect can't occur before the DP O_Answer.

In the embodiments of the present invention as described above, the BCSM in the MSC 18/SSF 17 is the Originating BCSM, and the DPs used in the examples are the DPs of the O-BCSM. As will be clear to the skilled person, the present invention is also applicable to other BCSMs, such as the T-BCSM (Terminating BCSM) in GMSC (Gateway MSC) and T-BCSM in VMSC (Visited MSC). The invention may also be applied for trunk based triggering; that is, cases whereby service triggering takes place in an arbitrary MSC 18 in the communication network, not being the serving MSC, GMSC or VMSC for the call.

In addition, the principle of the invention may also be applied to the State Models that are used for CAMEL control of SMS (Short Message Service, in MSC or SGSN (Serving GPRS Serving Node) and CAMEL control of GPRS (in SGSN and GGSN (Gateway GPRS Serving Node)).

Furthermore, it is foreseeable that embodiments of the present invention may also be applied to other network types than GSM/UMTS. When IN service triggering takes place in the wire line network (PSTN), then the implicit arming of DPs take place in e.g. a Local Exchange or Transit Exchange.

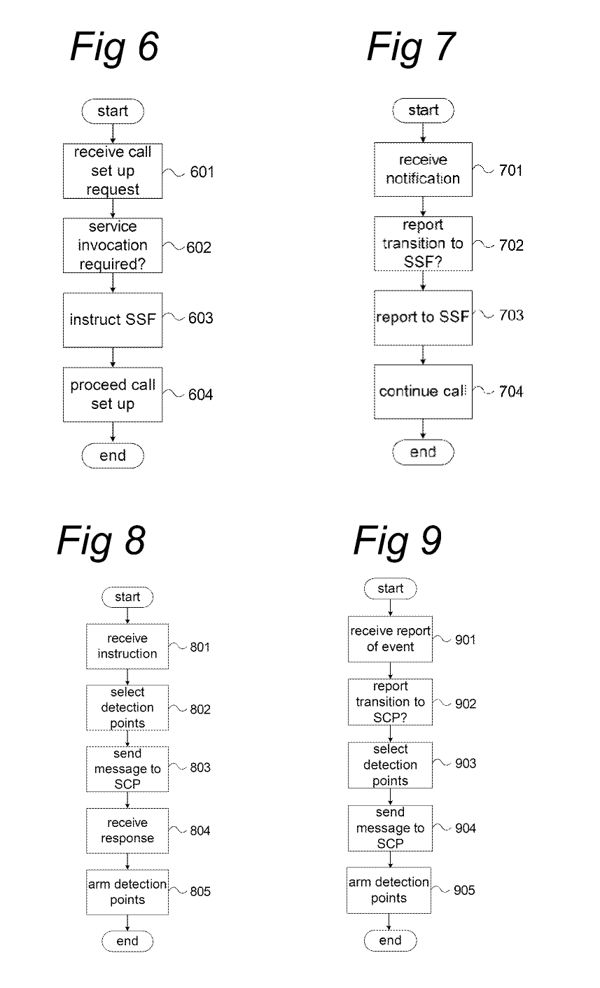

The present invention may also be described in more generalised embodiments, with reference to the FIGS. 6-13.

In FIG. 6, a flow diagram is shown of steps taken by the MSC 18 (a switching node in a telecommunications network) in order to execute an embodiment of the present invention. In step 601, a call set up request is received by the MSC 18, e.g. from the originating terminal 1. The MSC 18 then determines in step 602 whether or not a service invocation is required towards the intelligent network (comprising the SSF 17 (service switching entity) and SCP 16/SCF 19 (service control entity)). If affirmative, the MSC 18 instructs the SSF 17 in step 603, and immediately proceeds with the call set up in step 604, without waiting for any instruction, message or confirmation from the SSF 17.

In FIG. 7, a similar flow diagram is shown, illustrating the steps taken by the MSC 18 in a further embodiment of the present invention, i.e. when a call between originating terminal 1 and destination terminal 2 is already existing in the telecommunications network. An event may be generated during the call, which may be represented in a first state model having a plurality of detection points. A transition to a detection point as a result of the event may then be notified to the MSC 18 (step 701). The MSC 18 determines whether or not this transition needs to be reported to the SSF 17 (step 702), in order to be able to inform an intelligent network service. If indeed this is the case, the MSC 18 reports the transition to the SSF 17 (step 703), and immediately continues with the ongoing call (step 704) without suspending the call.

In FIG. 8, a flow diagram is shown illustrating the steps taken by the SSF in the present invention embodiments. After receiving an instruction from the MSC 18 (step 801), the SSF 17 selects a predefined set of detection points in step 802. Subsequently, the SSF 17 invokes an intelligent service in the SCP 16 (step 803), e.g. by sending an Initial Detection Point message, and waits for a response from the SCP 16 to the message (step 804). The response may comprise a TCAP identifier to enable maintenance of the dialogue between SSF and SCP. Once the response is received, the selected detection points are armed (step 805).

In FIG. 9, a similar flow diagram is shown for steps taken by the SSF 17 in a further embodiment, in the case a call is already in progress between the originating and destination terminals 1, 2. An event may be generated during the call, which is received by the SSF 17 via the report of step 703 in FIG. 7 (step 901). The SSF 17 then determines in step 902 whether or not the transition caused by the event needs to be reported to the SCP 16. If indeed this is the case, the SSF 17 selects a predefined set of detection points (step 903), and sends a message to the SCP 16 in step 904. Subsequently, the SSF 17 arms the selected detection points (step 905).

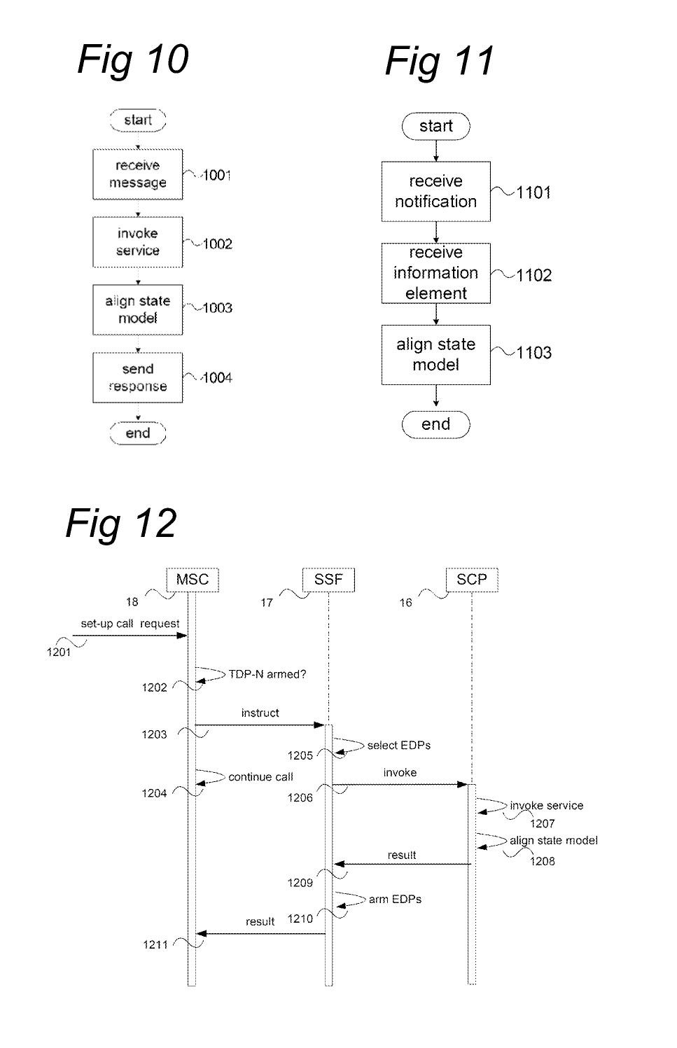

In FIG. 10 a flow diagram is shown of the steps taken by the SCP 16. When the message (step 803) is received from the SSF 17 (step 1001), the intelligent network service is invoked by the SCP 16 (step 1002). The SCP 16 aligns its internal state model (second state model), and then sends a response to the SSF 17 (step 1004). The response may comprise a TCAP identifier to enable maintenance of the dialogue between SSF and SCP.

In FIG. 11, again a similar flow diagram is shown, illustrating steps taken by the SCP 16 when a call is already in progress. Via the message sent by the SSF 17 (step 904) the SCP 16 is notified of the event indirectly (step 1101), and furthermore receives an information element indicating a predefined set of detection points to be armed (step 1102). The notification and the information element may be part of a single message. Then, the SCP 16 aligns the second state model in the invoked intelligent network service (step 1103).

The steps taken by the various elements in the telecommunications network and the intelligent network are also visualized in the timing diagram of FIG. 12, showing an embodiment of the present invention. After receiving a set up call request (1201), the MSC 18 determines whether or not a trigger detection point of the notify type (TDP-N) is armed (1202). If this is the case, the MSC 18 instructs the SSF 17 (1203) accordingly, after which the SSF 17 selects event detection points to be armed for the specific intelligent network function (1205).

In the meantime, the MSC continues the call set up process, as indicated by 1204. The SSF 17 then invokes the intelligent network service (1206) using a message to the SCP 16. The SCP 16 subsequently initiates the service (1207), aligns its internal state model (1208), and reports back to the SSF 17 (1209). The SSF 17 then arms the selected group of detection points (1210) and informs the MSC 18 (1211) accordingly.

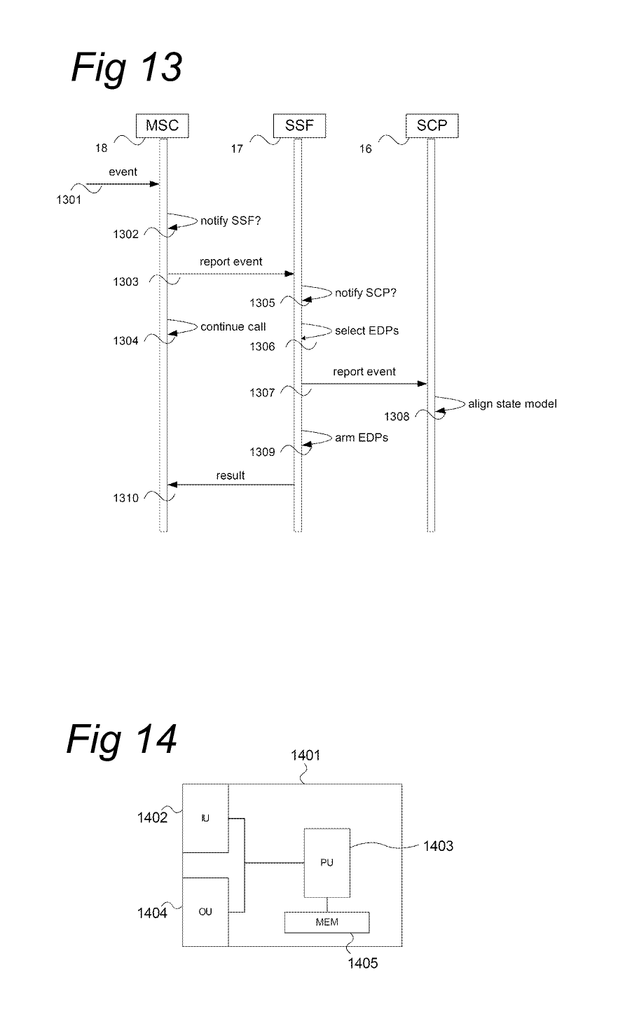

In FIG. 13, a similar timing diagram is shown for the case that an intelligent network service is to be initiated during a call after a certain event has occurred. After receiving the event notification (1301), the MSC 18 determines whether or not to notify the SSF 17 (1302). If this is the case, the MSC 18 reports the event to the SSF 17 (1303) accordingly, after which the SSF 17 determines whether or not is it necessary to notify the SCP 16 (1305), and to select a predetermined group of detection points for this intelligent service (1306). In the meantime, the MSC continues the call, as indicated by 1304. The SSF 17 then reports the event (1307) using a message to the SCP 16. The SCP 16 subsequently aligns its internal state model (1308). The SSF 17 then arms the selected group of detection points (1309) and informs the MSC 18 (1310) accordingly.

1. A method for invoking a service in a telecommunications network including a switching node and an intelligent network, the intelligent network further including a service control entity and a service switching entity, comprising the steps of:
receives a request to set up a call at said switching node;
determines if the call requires invocation of a service in the intelligent network, and if so:
instructs the service switching entity; and
proceeds with the set up of the call at said switching node;
wherein said set up of the call is executed before an instruction from the service switching entity is received.

2. The method according to claim 1, wherein the step of determining if the call requires invocation of a service in the intelligent network further comprises the step of checking whether there is a trigger detection point in notify mode applicable for the call.

3. The method according to claim 1, wherein said step of instructing the service switching entity further comprises the step of sending an indication that the set up of the call is not suspended.

4. The method according to claim 1, further comprising the steps of:
receiving a notification that a first state model in the switching node having a plurality of detection points associated with the call has made a transition to a detection point;
determining if the transition is to be reported to the service switching entity and if so
reporting the transition; and
continuing the call before an instruction from the service switching entity is received.

5. A method for invoking a service in a telecommunications network including a switching node and an intelligent network, the intelligent network including a service control entity and a service switching entity, comprising the steps of:
receives an instruction from the switching node at said service switching entity;
selects a predefined set of detection points in accordance with the received instruction;
sends a message to the service control entity;
receives a response from the service control entity; and
arms the detection points from the selected predefined set.

6. The method according to claim 5, wherein the instruction comprises an indication that the call set up is not suspended.

7. The method according to claim 5, wherein the message is an Initial Detection Point message comprising an information element indicating the predefined set of detection points and comprising an indication that the call set up is not suspended.

8. The method according to claim 5, further comprising the steps of:
receiving a report that a first state model in the switching node having a plurality of detection points associated with the call has made a transition to a detection point;
selecting a predefined set of detection points in accordance with the received notification;
determining if the transition is to be reported to the service control entity;
if so, sending a message comprising an indication of the transition and comprising an information element indicating the predefined set of detection points to the service control entity; and
arming the detection points from the selected predefined set.

9. A method for invoking a service in a telecommunications network including a switching node and an intelligent network, the intelligent network including a service control entity and a service switching entity, comprising the steps of:
receives a message from the service switching entity comprising an information element indicating a predefined set of detection points to be armed by the service switching entity;
invokes the service at said service control entity;
aligns a second state model in the invoked service in accordance with the predefined set of detection points; and
sends a response to the service switching entity.

10. The method according to claim 9, wherein the message from the service switching entity is an Initial Detection Point message.

11. The method according to claims 9, wherein the message comprises an indication that the call set up is not suspended.

12. The method according to claim 9, further comprising the steps of: receiving a message comprising a notification that a first state model in the switching node having a plurality of detection points associated with the call has made a transition to a detection point, and comprising an information element indicating a predefined set of detection points to be armed by the service switching entity; and
aligning the second state model in the invoked service in accordance with the transition and with the predefined set of detection points.

13. A method for invoking a service in a telecommunications network including a switching node and an intelligent network, the intelligent network including a service control entity and a service switching entity, comprising the steps of:
receives a request to set up a call at said switching node;
determines if the call requires invocation of a service in the intelligent network, and if so:
instructs the service switching entity;
proceeds set up of the call before an instruction from the service switching entity is received,
wherein the service switching entity further:
selects a predefined set of detection points in accordance with the received instruction;
sends a message to the service control entity;
receives a response from the service control entity;
arms the detection points from the selected predefined set,
wherein the service control entity further:
invokes the service;
aligns a second state model in the invoked service in accordance with the predefined set of detection points; and
sends a response to the service switching entity.

14. The method according to claim 13, wherein the switching node further:
receives a notification that a first state model in the switching node having a plurality of detection points associated with the call has made a transition to a detection point;
determines if the transition is to be reported to the service switching entity and if so
reports the transition;
continues the call before an instruction from the service switching entity is received,
wherein the service switching entity further:
receives a report that a first state model in the switching node having a plurality of detection points associated with the call has made a transition to a detection point;
selects a predefined set of detection points in accordance with the received notification;
determines if the transition is to be reported to the service control entity;
if so, sends a message comprising an indication of the transition and comprising an information element indicating the predefined set of detection points to the service control entity;
arms the detection points from the selected predefined set, and wherein the service control entity further:
receives a message comprising a notification that a first state model in the switching node having a plurality of detection points associated with the call has made a transition to a detection point, and comprising an information element indicating a predefined set of detection points to be armed by the service switching entity; and
aligns the second state model in the invoked service in accordance with the transition and with the predefined set of detection points.

15. A switching node for a telecommunications network, connectable to an intelligent network, the intelligent network including a service control entity and a service switching entity, the switching node comprising
a processing unit,
an input unit connected to the processing unit and
an output unit connected to the processing unit, wherein the input unit and output unit are connectable to further switching nodes, the input unit being arranged for receiving a request to set up a call, the processing unit being arranged for determining if the call requires invocation of a service in the intelligent network, and if so to instruct the service switching entity and to proceed set up of the call using the output unit, wherein the processing unit is further arranged to proceed set up of the call before an instruction from the service switching entity is received.

16. The switching node according to claim 15, wherein the processing unit is further arranged to determine if the call requires invocation of a service in the intelligent network by checking whether there is a trigger detection point in notify mode applicable for the call.

17. The switching node according to claim 15, wherein the processing unit is further arranged to instruct the service switching entity by sending an indication that the set up of the call is not suspended.

18. The switching node according to claim 15, wherein the input unit is further arranged to receive a notification that a first state model in the switching node having a plurality of detection points associated with the call has made a transition to a detection point, and wherein the processing unit is further arranged to determine if the transition is to be reported to the service switching entity and if so, to report the transition and to continue the call before an instruction from the service switching entity is received using the output unit.

19. A service switching entity for an intelligent network which provides intelligent network services to users of a telecommunications network, the intelligent network further including a service control entity connectable to the service switching entity, the service switching entity being connectable to a switching node in the telecommunications network, comprising:
a processing unit,
an input unit connected to the processing unit and
an output unit connected to the processing unit, wherein the input unit is arranged to receive an instruction from the switching node, the processing unit is arranged to select a predefined set of detection points in accordance with the received instruction, and to send a message to the service control entity using the output unit, to receive a response from the service control entity using the input unit, and to arm the detection points from the selected predefined set.

20. The service switching entity according to claim 19, wherein the instruction comprises an indication that the call set up is not suspended.

21. The service switching entity according to claim 19, wherein the message is an Initial Detection Point message comprising an information element indicating the predefined set of detection points and comprising an indication that the call set up is not suspended.

22. The service switching entity according to claim 19, wherein the input unit is further arranged to receive a report that a first state model in the switching node having a plurality of detection points associated with the call, has made a transition to a detection point, the processing unit is further arranged to select predefined set of detection points in accordance with the received notification, to determine if the transition is to be reported to the service control entity, and if so, to send a message comprising an indication of the transition and an information element indicating the predefined set of detection points to the service control entity using the output unit, and to arm the detection points from the selected predefined set.

23. A service control entity for an intelligent network which provides intelligent network services to users of a telecommunications network, the service control entity being connectable to a service switching entity in the intelligent network, comprising:
a processing unit,
an input unit connected to the processing unit and
an output unit connected to the processing unit, wherein the input unit is arranged to receive a message from the service switching entity comprising an information element indicating a predefined set of detection points to be armed by the service switching entity, and wherein the processing unit is arranged to invoke the service, align a second state model in the invoked service in accordance with the predefined set of detection points, and to send a response to the service switching entity using the output unit.

24. The service control entity according to claim 23, wherein the message from the service switching entity is an Initial Detection Point message.

25. The service control entity according to claim 23, wherein the message comprises an indication that the call set up is not suspended.

26. The service control entity according to claim 23, wherein the input unit is further arranged to receive a message comprising a notification that a first state model in the switching node having a plurality of detection points associated with the call has made a transition to a detection point, the notification comprising an information element indicating a predefined set of detection points to be armed by the service switching entity, and wherein the processing unit is further arranged to align the second state model in the invoked service in accordance with the transition and with the predefined set of detection points.

27. (canceled)
